(19) United States
(12) Patent Application Publication
(10) Pub. No.: US 2009/0279461 A1
(43) Pub. Date: Nov. 12, 2009

(54) Access terminal router implementation on enhanced HRPD

(76) Inventors: Sudarshan A. Rao, Bengaluru (IN); Subramanian Vasudevan, Morristown, NJ (US); Jialin Zou, Randolph, NJ (US)

Correspondence Address: Docket Adminstrator (Room 2F-192);Alcatel Lucent, 600-700 Mountain View Avenue, Murray Hill, NJ, 07974-0636, US

(21) Appl. No.: 12/319,117

(22) Filed: Dec. 31, 2008

Related U.S. Application Data
(63) Continuation-in-part of application No. 12/286,417, filed on Sep. 30, 2008.
(60) Provisional application No. 61/127,286, filed on May 12, 2008.

(51) Int. Cl. H04L 5/14; H04W 4/00

(52) U.S. Cl. 370/295; 370/328

(57) ABSTRACT

An enhanced access terminal (AT) that can serve as a “proxy wireless over-the-air backhaul or relay” is provided, to connect a base station with no backhaul to its neighboring fully functional base station that is connected to the NMS. In a further embodiment, the AT routing and relaying capability provided by the invention is extended to new OFDM based air-interface technologies being considered for 4^{th} generation cellular standards such as LTE, UMB and WiMAX.

### RELATED APPLICATION

This application is a continuation in part of U.S. patent application Ser. No. 12/286,417, filed Sep. 30, 2008, published ______ as US Published application Ser. No. ______, the subject matter thereof being fully incorporated herein by reference. This application further claims priority pursuant to 35 U.S.C. Sec 119(e) to U.S. Provisional Application No. 61/127,286, filed May 12, 2008, entitled ACCESS TERMINAL ROUTER IMPLEMENTATION ON ENHANCED HRPD, the subject matter thereof being fully incorporated herein by reference.

### FIELD OF THE INVENTION

The invention is related to communication systems and more particularly to systems and methods for routing traffic in wireless communication systems.

### BACKGROUND OF THE INVENTION

A traditional wireless access network consists of a number of base stations (access points) connected to a centralized controller (radio network controller/base station controller) using wired links (copper, co-axial cable, fiber). The radio network controllers are connected back to circuit-switches or packet-data routers which in turn connect to the wired telecommunications infrastructure (the core network). This traditional, hierarchical network is shown in FIG. 1.

In typical base station deployments in current networks, a wired connection is usually required from each base station to the controller and then onwards to the core network. In the vast majority of cases, these wired links are T1, E1, Ethernet or fiber links. In some rare cases, specialized dedicated line-of-sight microwave links are employed that use separate spectrum. Implementation of such dedicated backhaul connections is usually expensive. There may also be pairs of base stations in an existing network for which a dedicated backhaul connection can not be reliably or economically implemented. It is therefore worth considering alternative approaches to reducing backhaul costs. One such alternative is to somehow provision wireless backhaul links between the base stations themselves and thereby provide the backhaul communications path. Furthermore, it would be desirable not to dedicate separate spectrum and specialized equipment for such backhaul.

In the case of fault isolation and trouble-shooting of base-stations, techniques in current cellular networks rely on the ability of the network operators to correlate information from many diverse sources. Quite often, the back-haul connection is leased from third-party service providers. Many times, when a lack of service is detected from a base-station, the root-cause cannot be clearly isolated to the wired network or the base-station RF chain for several hours, if not longer. There is no other mechanism available today to log-in to affected base-stations remotely when a backhaul may be malfunctioning. A site visit is required by a technician to confirm or rule out a mal-functioning base-station. This very expensive site visit could be avoided if another mechanism were made available to diagnose base-stations remotely.

Further, the actual numbers of infrastructure nodes (base stations or access points) is likely to increase by a few orders of magnitude. Typically, each of the large service provider networks today consist of in excess of 50,000 cells sites at which base stations are located. It is not unrealistic to expect such numbers to grow by a factor of 100 to about 5 million. Such large number of base stations will be needed to ensure truly ubiquitous data coverage. It is also likely that many of these new access points cannot be easily supported with a wired backhaul to the core network.

### SUMMARY OF INVENTION

To address the problems described in the Background section, a methodology for routing packets via an access terminal (AT) between base stations (access points), using wireless technology, is disclosed.

In an exemplary embodiment, the access-terminal routing capability may be used to provide a wireless, meshed backhaul between base stations using existing wireless-access resources (time, bandwidth, code-space, power), protocols, and base station infrastructure. Thus, a means to extend the coverage of existing networks by adding standalone base stations without wired or specialized wireless backhaul is provided.

Essentially, with the methodology of the invention, an AT can serve as a “proxy router” when called upon to do so. The ability to use the AT to route packets between base-stations provides added flexibility to configure and control base-stations and also redundancy in case existing backhaul is congested or broken.

In a further embodiment, the AT routing and relaying capability provided by the invention may be extended to new OFDM based air-interface technologies being considered for 4^{th} generation cellular standards such as LTE, UMB and WiMAX.

In particular, the further embodiment is focused on an enhancement of the existing HRPD air-interface. Specifically, a new backhaul routing protocol is provided for the ATR by modifying the existing HRPD air interface protocol stack. The ATR supports parallel self traffic flows and backhaul flows simultaneously. The backhaul traffic flow and self traffic flow are differentiated by a traffic type indication. The QoS of the ATR backhaul stream is supported. The inbound and outbound ATR backhaul traffic flows and the ATR self traffic can be transmitted simultaneously. Walsh codes are employed to separate the concurrently transmitted parallel streams from an ATR. Independent power controls are applied to different air links when an ATR conducts parallel transmissions over different air links. The backhaul traffic from a standalone base station is thus routed to a base station connected with an RNC. The ATR backhaul stream could be negotiated through a simple request/response mechanism.

Wireless Access Terminal Router (ATR) implementation on HRPD RevB enables the capability of centralized backhaul, provides low cost edge coverage and low cost femto solutions at the air interface with HRPD. The features with generic nature could also be applied to other radio access technologies. The invention could provide significant cost savings for various applications and lead to a brand new business model.

### BRIEF DESCRIPTION OF THE FIGURES

FIG. 1 provides a schematic illustration of an hierarchical wireless network

FIG. 2 schematically illustrates differentiation among the ATR backhaul flows and the ATR self flows under the the ATR backhaul routing protocol of the invention.

FIG. 3 FIG. 3 schematically depicts an approach for maintaining the end to end QoS of the ATR backhaul flows over multiple hops

FIG. 4 schematically illustrates an illustrative multiplexing of backhaul and self traffic for an ATR.

FIG. 5 provides a flow diagram for information exchange between an unwired BTS and a tethered BTS communicating via an ATR.

FIG. 6 provides a flow diagram for information exchange between a tethered BTS and an unwired BTS communicating via an ATR, where the communication is originated by the T-BTS.

### DETAILED DESCRIPTION OF THE INVENTION

In the parent application (U.S. Ser. No. 12/286,417) for this continuation in part application, the inventors disclosed a new wireless relay function implemented in a wireless mobile unit, identified as a wireless Access Terminal Router (ATR). The present continuation-in-part application is directed to an application of that ATR relay function in the management of fixed elements in a wireless system.

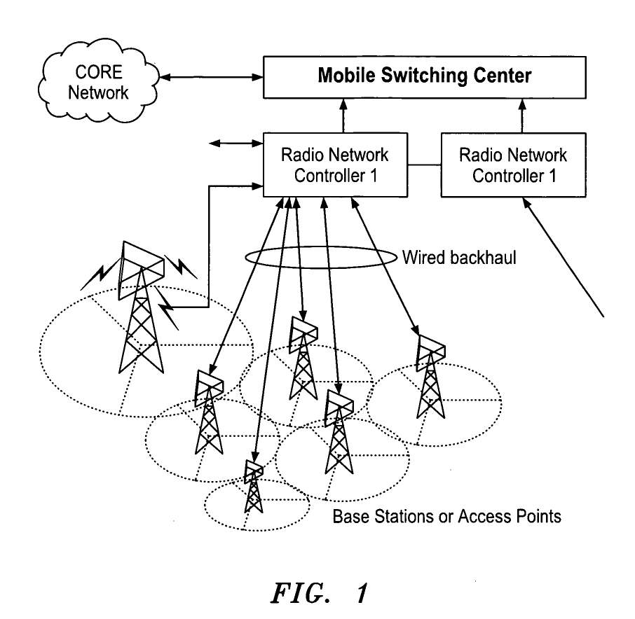

With the ATR concept, the mobile unit is not only in communication with base stations for its own traffic, but also carries the backhaul traffic from one or more base stations which stand alone and do not have wire/backhaul connection with networks. The ATR concept is schematically illustrated in FIG. 1. The ATR functions are, however, not presently supported in the High Rate Packet Data (HRPD) air interface standard. New protocols are required for the ATR capabilities, as disclosed herein.

The basic idea of the invention is to create the new protocols in the air interface, for example HRPD rev-B single or multi-carrier. A new backhaul routing protocol is created for ATR by modifying the HRPD protocol stack. ATR supports parallel self traffic flows and backhaul flows simultaneously. The backhaul traffic flow and self traffic flow can be differentiated by a traffic type indication. The QoS of the ATR backhaul stream is supported by the modified protocol. The inbound and outbound ATR backhaul traffic flows and the ATR self traffic can be transmitted simultaneously. Walsh codes are employed to separate the concurrently transmitted parallel streams from an ATR. Independent power controls are applied to different air links when an ATR conducts parallel transmissions over different air links. The backhaul traffic from the standalone base station, or “BTS,” is thus routed to the BTS connected with RNC. The ATR backhaul stream can be negotiated through a simple request/response mechanism. Mechanisms are also developed to support the ATR sector switches.

The following assumptions underlie the detailed discussion hereafter of the methodology of the invention. One or more ATRs are always available to a Tethered BTS (T-BTS)—defined as a BTS with backhaul connection—for it to connect to a neighboring BTS without backhaul. Each BTS without backhaul, or unwired BTS (UWBTS), knows a route to one or more BTSs with backhaul. There is no explicit broadcast information from a BTS indicating the presence or absence of a backhaul to the AT. Thus, the AT does not know whether or not a BTS has backhaul or not. A multiple BTS uplink active set and a multiple BTS downlink active set are supported, and RLP is enabled at each air interface. Store and forward capability is provided together with the RLP.

### New ATR Backhaul Routing Protocol

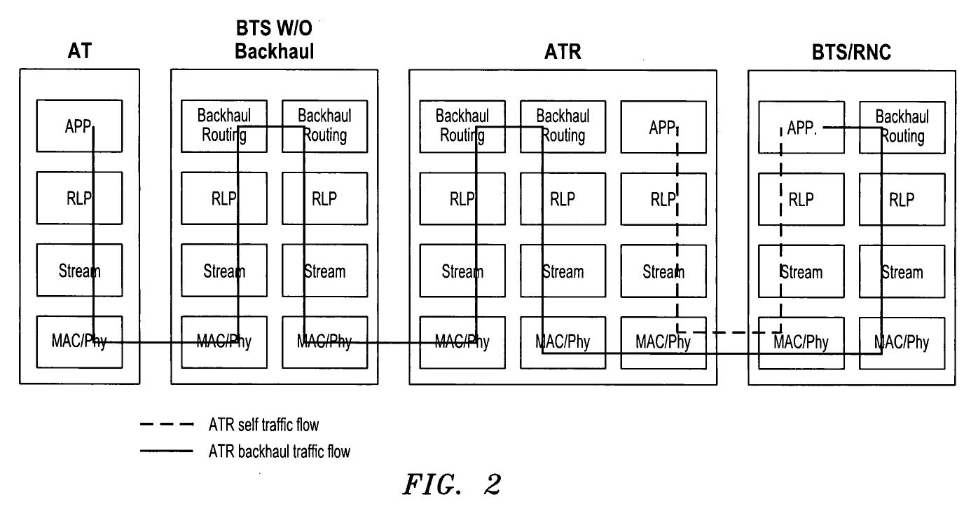

The overall ATR backhaul routing function is schematically illustrated in FIG. 2. As will be seen in the “ATR” labeled block, the ATR operates to perform both the conventional AT function of direct communication between the AT and a BTS (illustrated in the rightmost column of functions in the block—“APP” “RLP” “Stream” and “MAC/Phy”) and a relay function for communication between a BTS without backhaul and a BTS with backhaul (illustrated by the two leftmost function columns).

The ATR backhaul routing protocol resides in the HRPD application layer and conducts the ATR backhaul flow encapsulation. The encapsulation functions include (a) adding the backhaul flow indication at the packet header and (b) adding the source and destination identification (pseudo noise (PN) code of the source and destination sector).

As illustrated in FIG. 2, the ATR backhaul routing protocol operates to differentiate the ATR backhaul flows and the ATR self flows. That operation includes separating the backhaul flows into separate stream/flow—i.e., when there is backhaul traffic to be handled, a separate stream will be used from the stream for normal AT traffic. To support the flow differentiation, a dedicated protocol stack instance and RLP are provided for each air link between the ATR and the UWBTS, the ATR and the T-BTS, and the AT and the UWBTS.

Further, the RLP flows in the backhaul stream operate at each air interface and support the QoS for the stream based on the QoS at the flow source. Store and forward capability is expected to function together with the RLP.

The ATR backhaul routing protocol also supports multiple uplink active sets and multiple downlink active sets to allow multiple routes from an AT going through multiple UWTBSs and ATRs to the T-BTSs.

In performing its routing function, the ATR operates to route the flow either to the addressed application or just performs pass-through based on the self/backhaul indication of the flows. The ATR backhaul routing protocol also assists the lower layer to determine the target BTS. The routing protocol resides in the HRPD application layer and conducts the ATR backhaul flow encapsulation. It adds the backhaul flow indication and the source and destination ID (PN of the source and destination sector) at the packet header. To assist such routing, the UWBTS knows all the routes to the neighboring T-BTS. Each UWBTS should maintain a list of the nearby T-BTSs with their associated sector PNs. The UWBTS and pre-deployed available ATRs can then link the route to a given T-BTS with its associated sector PNs.

When a UWBTS receives an application flow from a source AT, it determines a route to a T-BTS and broadcasts the backhaul connection request for the next destination with PNx first (where PNx is the identity of an available neighboring sector nearby selected by the UWBTS that may connect to the intended destination). If a nearby ATR offers a backhaul connection to PNx, the negotiation procedure for the ATR backhaul should be started. If no nearby ATR offers the backhaul connection to PNx, the UWBTS should broadcast an ATR backhaul request with PNy of another T-BTS sector (where PNy is the identity of the next available neighboring sector selected by the UWBTS that may assist in routing to the intended destination), till an ATR backhaul is found for connection to a T-BTS.

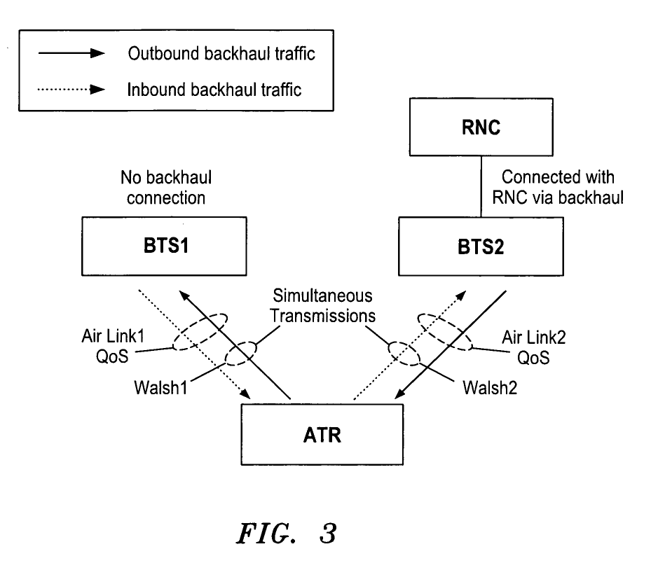

The destination sector PN embedded in the ATR backhaul request is used by the ATR to acquire the pilot of the next destination sector. For the inbound traffic flow—inbound referring to flow towards a T-BTS from an UW-BTS via an ATR, as illustrated in FIG. 3, the destination sector is a sector of the T-BTS. For the outbound traffic flow—outbound referring to flow away from T-BTS towards an UW-BTS via an ATR, the destination sector is a sector of the UWBTS linked to the source AT. When the UWBTS encapsulates the inbound ATR backhaul packets, it should include the source sector PN (i.e., its own PN). The destination PN need not be included in the packet header for an ATR that only serves one destination T-BTS. The ATR will have already obtained the PN of the destination T-BTS via the ATR backhaul request. However, for an ATR that serves more than one destination T-BTS, the destination PN should be included in the packet header.

The source-sector PN of the un-wired BTS sector will be required by the T-BTS. The T-BTS will use that source sector PN as the destination PN to encapsulate the packet and send back to the UWBTS. Note, though, that the T-BTS may not need to include the source sector PN when it conducts the encapsulation for the ATR backhaul packets.

### QoS Support for Simultaneous ATR Backhaul Flows

FIG. 3 schematically depicts an approach according to the invention for supporting the QoS of the application flows through the ATR backhaul, for maintaining the end to end QoS of the ATR backhaul flows over multiple hops. According to that approach, the QoS of the original application flow at the source is used as the end-to-end requirement over the entire ATR backhaul route. The number of the hops over the entire ATR backhaul route is used to determine the QoS requirement at each air link over the ATR backhaul route. For example, the delay budget at an air link of a particular hop on the backhaul route should be derived from the total delay budget of the entire ATR backhaul route and the number of the hops on the ATR backhaul route.

With the approach of FIG. 3, the inbound and outbound backhaul streams and the ATR self traffic flows may be transmitted simultaneously by the ATR. For an HRPD/CDMA application using a single carrier, the ATR parallel transmission flows (inbound/outbound/self) are separated with different Walsh codes. Independent QoS based resource allocation and independent power control is applied to the parallel ATR transmission flows at a given air link in the backhaul route. QoS based resource allocation is applied differently at different air links based on the QoS requirement, such as the delay budget and the channel condition of that particular air link.

More than one Walsh code could be applied to the inbound or outbound streams transmitted by an ATR. The number of the Walsh codes allocated to an inbound or outbound stream may be proportional to the ATR transmission rate of the stream.

The ATR backhaul inbound, backhaul outbound and the ATR self data streams can be transmitted concurrently over different air links. Independent power control loops are applied to each independent air links subject the aggregate AT total power constraint. Interference cancellation can be applied at the source BTS whose backhaul data are relayed by the ATR to the destination BTS. This interference is generated by the ATR relay/transmit for the source BTS's backhaul traffic.

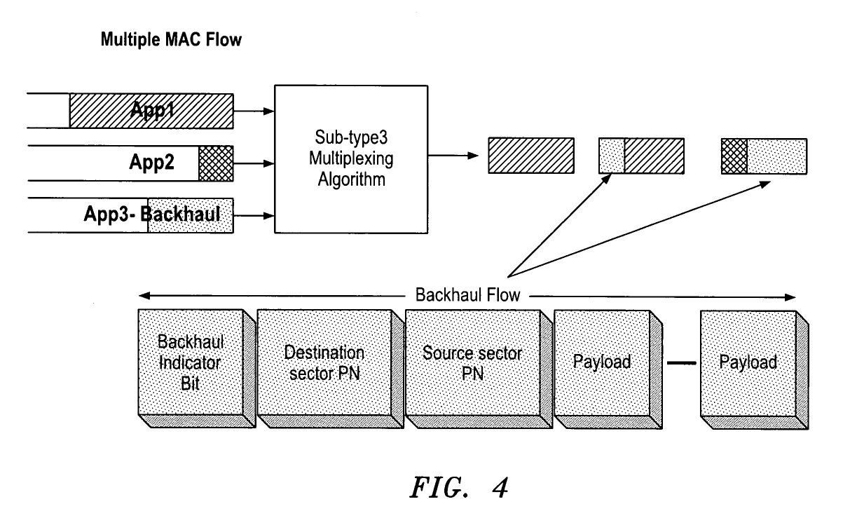

Within the inbound or outbound traffic stream, the ATR backhaul traffic may be multiplexed with the ATR self application traffic at the MAC layer before transmission if the QoS of all the flows could be met, as illustrated in FIG. 4. In the figure, three different applications are illustrated. Application type 1 and application type 2 are refer to traffic that is related to a normal access-terminal user application (for example, voice or email) that are intended for the specific AT. Application 3, on the other hand, is directed to backhaul type traffic between the BTS's as shown in the figure. FIG. 4 is intended to illustrate that the routing protocol tags the backhaul traffic with a backhaul indicator bit to differentiate it from the ATR's own traffic. This allows the network to treat application 3 traffic as special and route it according to the destintaton and source addresses provided. Application 1 and application 2 traffic is treated as normal AT related traffic.

Otherwise, separate flows should be used for the self traffic and the backhaul traffic, with different Walsh codes in reverse link and independent per flow based power control and resource allocation applied.

The inbound backhaul traffic and ATR self traffic may be targeted to different T-BTS based on the channel conditions and the QoS requirements of different traffic flows.

### The ATR Backhaul Flow Negotiation

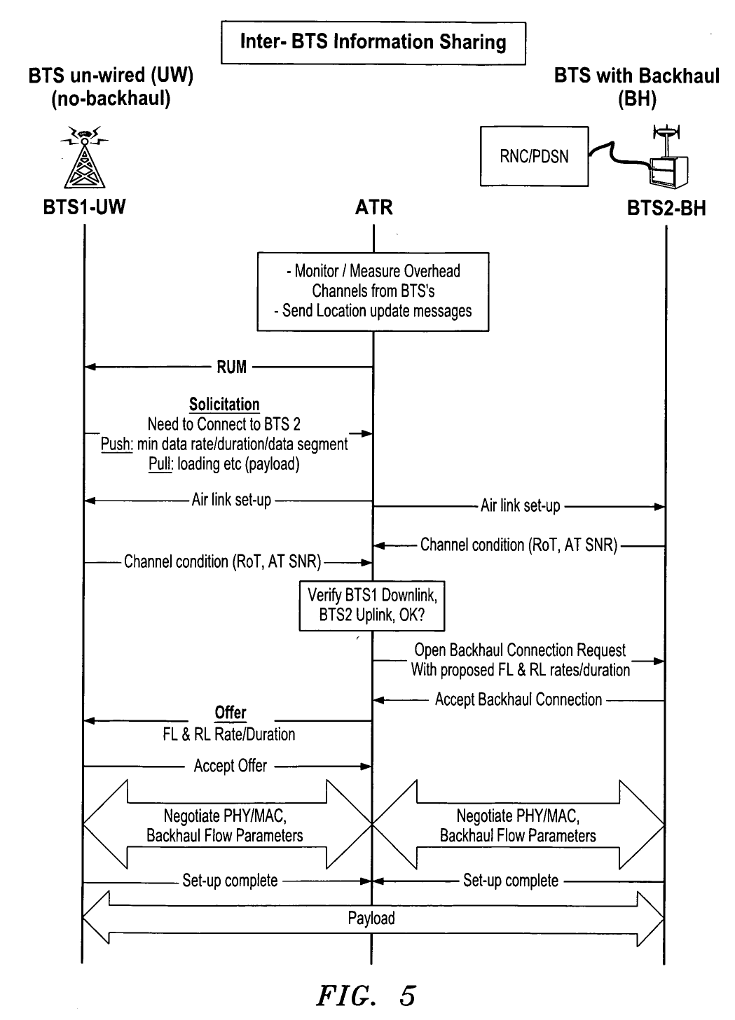

FIG. 5 provides a flow diagram for information exchange between an unwired BTS and a tethered BTS communicating via an ATR. As shown in the figure, the ATR should send the Route Update Message (RUM) (as defined in the CDMA2000 EvDO standard (C.S0024-B)) following the existing HRPD rule.

When a connection is enabled from a source AT to an UWBTS, the UWBTS will send a broadcast ATR backhaul request (solicitation). The initial ATR backhaul request sent by the UWBTS will include the destination PN indicated by the source AT. If the AT preferred destination PN is not reachable through an ATR backhaul, the UWBTS will send the request again with alternative destination PN.

While the source AT is connected with the UWBTS, it could keep sending the preferred destination PN. If the current destination PN of the available ATR backhaul is not the one the source AT preferred, the UWBTS may send the request again with the desired destination PN. Alternatively, while the source AT is connected with the UWBTS, the source AT may change its preferred destination PN, similarly causing the UWBTS to send the request again with the new destination PN.

When an ATR has received the ATR backhaul request message from the UWBTS, it will measure the pilot of the destination PN. If the pilot of the destination PN is not strong enough (above a threshold), the ATR will ignore the request message. Otherwise, the ATR with bring up a connection to the sector with the destination PN. And through the connection to the destination sector, the ATR will get the measurement information (such as the received ATR SNR) from the destination T-BTS.

Based on the received information, such as RoT, SNR etc., the ATR will send an offer message back to the UWBTS with the rate and duration information to indicate how much ATR backhaul traffic could be supported by this ATR. Once the offer is accepted by the UWBTS, Phy/MAC backhaul flow parameters, including all QoS parameters, are negotiated and the ATR backhaul enabled.

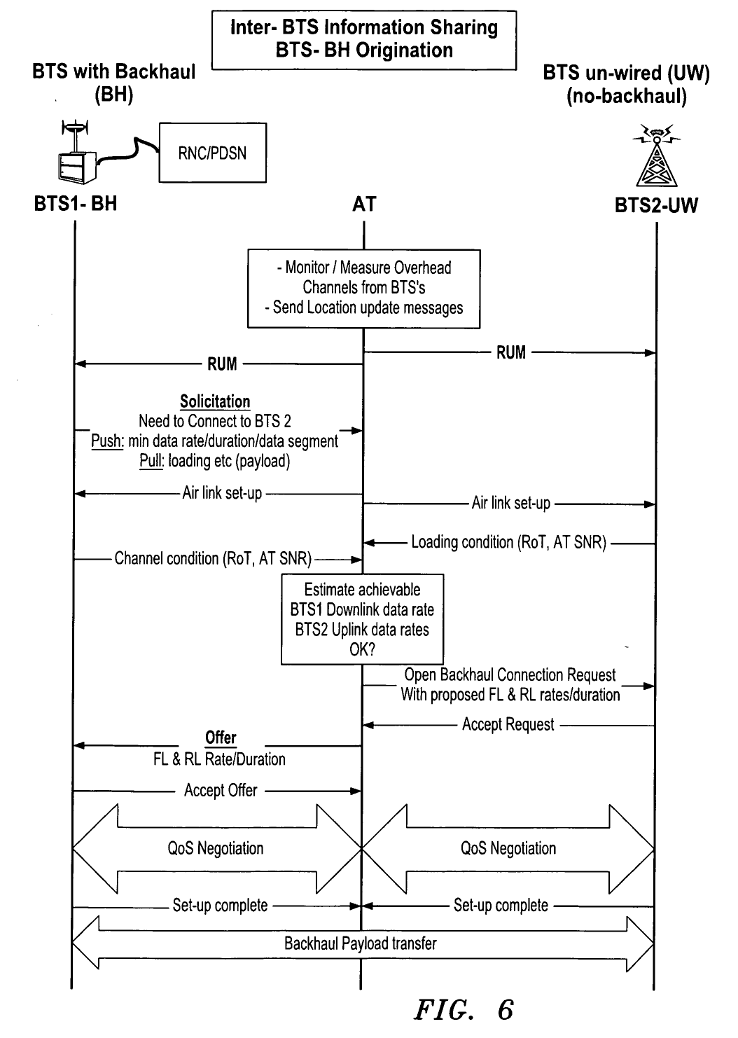

FIG. 6 shows a flow diagram for information exchange between a tethered BTS and an unwired BTS, via an ATR backhaul connection, where the communication is originated by the T-BTS. As with the AT/UWBTS origination case, the ATR should send RUM following the existing HRPD rule.

When a T-BTS is connected with an ATR backhaul, the T-BTS will maintain a map of the UWBTS destination PNs and the MACIDs which are associated with the in-use ATR backhauls If, on the other hand, there is no existing ATR backhaul for a desired UWBTS destination, the T-BTS will broadcast an ATR backhaul request message.

When an ATR has received the ATR backhaul request message from the T-BTS, it will measure the pilot of the destination PN. If the pilot of the destination PN is not strong enough (above a threshold), the ATR will ignore the request message. Otherwise, the ATR with bring up a connection to the sector with the destination PN. And through the connection to the destination sector, the ATR will get the measurement information (such as the received ATR SNR) from the destination UWBTS.

Based on the received information, such as RoT, SNR etc., the ATR will send an offer message back to the T-BTS with the rate and duration information to indicate how much ATR backhaul traffic could be supported by this ATR. Once the offer is accepted by the UWBTS, backhaul flow parameters, including QoS, are negotiated and the ATR backhaul from the T-BTS to the UWBTS is enabled. The T-BTS would then direct packets with the corresponding destination PN to the UWBTS via the associated ATR backhaul.

Herein, the inventors have disclosed a method and system for implementing enhanced HRPD connectivity through use of an access terminal router. Numerous modifications and alternative embodiments of the invention will be apparent to those skilled in the art in view of the foregoing description.

Accordingly, this description is to be construed as illustrative only and is for the purpose of teaching those skilled in the art the best mode of carrying out the invention and is not intended to illustrate all possible forms thereof. It is also understood that the words used are words of description, rather that limitation, and that details of the structure may be varied substantially without departing from the spirit of the invention, and that the exclusive use of all modifications which come within the scope of the appended claims is reserved.

1. In a wireless communication system including an access terminal and at least two base stations, a method for providing a communications path between a first base station and a second base station via the access terminal comprising the steps of:
providing the access terminal with a transmission/reception capability complementary with that of both the first and second base stations; and
causing the access terminal to receive traffic transmitted by the first base station and in turn retransmit the message to the second base station.

2. The method of claim 1 including the further step of:
providing at least one of the base stations with a capability to locate and route messages from source to intended destination.

3. The method of claim 1 including the further step of:
providing an enabling protocol to enable access terminals and networks to negotiate and cooperate among one another.

4. The method of claim 1 wherein the access terminal is enabled to operate in separate modes, a first mode being said receipt of a message from a first base station and retransmittal of the message to the second base station (hereafter “backhaul mode”), and a second mode characterized by receiving a message transmitted by at least one of the base stations and in turn transmitting a response message to the at least one base station (hereafter “access mode”).

5. The method of claim 4 wherein air-interface resources are dynamically shared between the access and backhaul modes using a single set of device protocols.

6. An access terminal established to concurrently transmit via a wireless medium two or more independent streams of data to two or more base stations, each data stream being transmitted to a different base station.

7. The access terminal of claim 6 further established to concurrently receive two or more independent data streams from base stations to which the access terminal is transmitting data.

8 The access terminal of claim 7 wherein the access terminal transmits data received by it on a downlink from one base station via an uplink to another base station.

9. The access terminal of claim 8 further including a selector in the access terminal operative to determine the uplink on which data received on a particular downlink is to be transmitted.

10. The access terminal of claim 8 wherein the data received on a particular downlink is retransmitted on more than one uplink

11. The access terminal of claim 1 wherein the access terminal is owned and operated by a service provider of a wireless communication system including at least one of the first and second base stations.

12. The access terminal of claim 2 wherein the uplink and downlink are Frequency Division Duplexed.

13. The access terminal of claim 2 further including a determination by the access terminal of supportable data rates on each uplink-downlink channel pair based on control signaling transmitted between itself and ones of the first and second base stations.

14. The access terminal of claim 13 wherein the access terminal reports said supportable data rates in response to a solicitation for operation in the backhaul mode by the access terminal.

15. The access terminal of claim 2 established at a given location to provide wireless system coverage extension.

16. The access terminal of claim 2 wherein at least one of the first and second base stations is a Femtocell and the access terminal provides signaling and control for autoconfiguring the Femtocell.

17. The access terminal of claim 2 wherein the access terminal is established to monitor and report measurements and alarms for at least one of the first and second base stations.
